(19) United States
(12) Patent Application Publication
(10) Pub. No.: US 2026/0243726 A1
(43) Pub. Date: Aug. 20, 2026

(54) METHOD FOR CONTINUOUSLY USING SEPARATION MEDIUM

(71) Applicant: HITACHI HIGH-TECH CORPORATION, Tokyo (JP)

(72) Inventors: Hirokazu Kato, Tokyo (JP); Motohiro Yamazaki, Tokyo (JP); Isao Haraura, Tokyo (JP); Noriyuki Sumida, Tokyo (JP); Asami Terakado, Tokyo (JP)

(73) Assignee: HITACHI HIGH-TECH CORPORATION, Tokyo (JP)

(21) Appl. No.: 18/871,231

(22) PCT Filed: Aug. 10, 2022
(86) PCT No.: PCT/JP2022/030683

§ 371 Date: Dec. 3, 2024

(51) Int. Cl. G01N 27/447

(52) U.S. Cl. CPC G01N 27/44769; G01N 27/44791

(57) ABSTRACT

The method for continuously using a separation medium according to the present invention includes a separation medium filling step of filling a capillary with the separation medium, a first pre-run step of performing a pre-run, a first sample injection step of injecting a first-time sample into the capillary, a first electrophoretic step of applying a voltage to perform first electrophoresis, a second pre-run step of performing a pre-run after the first electrophoretic step, a second sample injection step of injecting a next-time sample into the capillary subjected to the second pre-run step, and a second electrophoretic step of performing next electrophoresis, and the method repeatedly performs the second pre-run step, the second sample injection step, and the second electrophoretic step a preliminarily set number of times.

### TECHNICAL FIELD

This invention relates to a method for continuously using separation medium.

### BACKGROUND ART

The proportion of the population aged 60 or over to the total population will increase in the future, and all developed countries will have super-aging societies. Against this backdrop, public interest in health has significantly increased in recent years, and there is growing interest in healthcare technologies to maintain health and longevity. Among these, genomic medicine is one of the technologies that is attracting the most attention. The genomic medicine is intended to literally apply genetic information of individuals to diagnosis and apply appropriate medical care to each patient. The device used to read the genetic sequence information is a DNA sequencer. In other words, it can be said that the DNA sequencer is one of representative analytical devices.

A human genome project aiming at analysis of the complete base sequence of the human genome was completed in 2003. Technology related to DNA sequencing has made a great progress from then to today, and various technologies related to various sequences have been developed. Among these, a technology referred to as next-generation sequencing is characterized by performing sequence decoding in a massively parallel manner. Thanks to this technological innovation, it is now possible to decode the human genome for less than 1,000 dollars.

However, a DNA reading method referred to as a Sanger method, which was adopted in the human genome project and is used in capillary sequencing, is still considered to be the golden standard in DNA sequencing. This is because the Sanger method has high base reading accuracy and has an advantage in terms of analysis cost per sample over other methods such as the next-generation sequencing. Therefore, the Sanger method used in the capillary sequencing is still an indispensable technique in research fields around the world.

One of the reasons why capillary sequencers have established such a strong position in the research field is the application of liquid polymers that allow a separation medium in a capillary. Before the widespread use of the capillary sequencers, DNA separation was typically performed using a gel solidified between two gel plates. However, preparing this gel was labor-intensive and placing a burden on users. However, it is proved that, by using a liquid polymer, electrophoresis can be performed by filling a flow path with the liquid polymer without producing a gel. The liquid polymer can continuously be measured by replacing the liquid polymer in the flow path after each measurement. In other words, it is possible to save a user the labor of producing gels.

With the liquid polymer, it is possible to continuously perform measurement merely by replacing the liquid polymer serving as the separation medium, while leaving the capillary as is. In addition, in a micro-channel chip using a solid separation medium (gel), the gel is solidified, and accordingly it is necessary to discard the chip after each measurement and prepare a new chip. This leads to increased running costs, which is a burden on users. Under such circumstances, the easily replaceable liquid polymer is one of advantageous features of capillary sequencers.

In addition, one of the most important requirements of users of capillary sequencers is the reduction of running costs. Reagents used in a capillary sequencer include an anode-side buffer, a cathode-side buffer, a liquid polymer, and the like and, among these, the most costly reagent is the liquid polymer, which is a medium for separating DNA. In order to reduce the running costs of this most costly liquid polymer, Nonpatent Literature 1 verifies whether or not a plurality of analyses can be performed with one fill of a liquid polymer into a capillary using a capillary sequencer manufactured by Beckman Coulter, Inc. A result of this verification showed that, when the liquid polymer was filled once, analytical performance deteriorated as the number of analyses was increased. In conclusion, it is stated that “Replacement of the separation matrix is simple and is not worth compromising the results with its reuse” (it is easy to replace the liquid polymer (in the capillary), and an experimental result should not be compromised by the reuse of the liquid polymer). In other words, it is highly recommended to replace the liquid polymer after each analysis, since reusing the liquid polymer impairs the analytical performance.

The cause of degradation of the liquid polymer by the plurality of analyses is decomposition of urea contained in the liquid polymers. In general, electrophoretic analysis in a capillary sequencer is performed by applying a high voltage of about 15 kV to a capillary end in a temperature environment at 60° C. Urea has a function of dissociating double-stranded DNA to single strands but, according to Nonpatent Literature 2, urea has a problem of being decomposed at a high temperature.

In addition, a capillary array used in the DNA sequencing typically uses pure glass that has not been chemically modified, and a surface thereof is covered with hydroxyl groups. Meanwhile, a buffer used in the capillary sequencing is an aqueous solution around pH 8.0, and glass surfaces of capillaries are negatively charged. Positive ions in the aqueous solution are adsorbed to the glass surfaces and, when a high voltage is applied to the capillary array in this state, positive ions on the glass surfaces are dragged to generate an electroosmotic flow. Since the electroosmotic flow has an effect of deteriorating DNA separation performance, a degree to which the electroosmotic flow is suppressed significantly affects analytical results. It is to be noted herein that a liquid polymer not only serves as a DNA separation medium, but also has a function of being adsorbed to the glass surfaces and preventing the electroosmotic flow. However, according to Nonpatent Literature 3, a decomposition product of urea has a function of inhibiting adsorption of the liquid polymer to the glass surfaces. As a result, with the decomposition of urea, the electroosmotic flow increases to reduce the DNA separation performance.

Note that an analytical process in the capillary sequencer can be divided into four steps: (1) polymer filling into the capillary array, (2) pre-run, (3) sample injection, and (4) electrophoresis.

Among these, the pre-run in (2) is a process in which, after the capillary array is filled with the liquid polymer, a voltage is applied only to the liquid polymer for about 3 minutes. This step is considered to be essential for removing impurities in the liquid polymer and necessary to prepare an optimum separation medium environment for analysis. Nonpatent Literature 4 reports that the application of the pre-run significantly improves protein separation in slab gels.

Currently, Thermo Fisher Scientific holds 90% of a capillary sequencer market. Thermo Fisher Scientific sells not only instruments, but also reagents and analysis software and provides customers with comprehensive sample-to-answer solutions. However, due to the powerful oligopoly thereof, the running costs of capillary sequencing remains high, and the black-box nature of the instruments restricts customer flexibility. Meanwhile, Thermo Fisher Science offers a wide variety of electrophoretic equipment and the like to thereby give more flexibility to customers.

A specific factor that keeps the running costs high is that the protocol for replacing the liquid polymer, which is the DNA separation medium, for each analysis is provided to the customer in a form that does not allow for changes. That is, when a customer fills a capillary array with a liquid polymer once, the customer is limited to one analysis using the liquid polymer. In other words, customers cannot perform the analysis a plurality of times with a single fill of the liquid polymer. Meanwhile, since the liquid polymer is most costly among reagents required for capillary sequence analysis, it has been difficult for customers to reduce the running costs of analysis.

Under such circumstances, several inventions have been proposed that can reduce the running costs of analysis. For example, Patent Literature 1 discloses a method for electrophoretic analysis in which heat generated in each capillary is dissipated from electrodes via a thermally conductive medium, and a temperature of each capillary during electrophoresis in action is maintained at a temperature of more than room temperature and equal to or less than 80° C. It is stated in Patent Literature 1 that such a configuration can prevent gel degradation and allows repeated electrophoretic analysis using the same gel.

Meanwhile, for example, Patent Literature 2 discloses a capillary electrophoretic device including a detector that detects a separated component and a means (migration end determination means) that determines the end of migration of a sample that migrates in a capillary. The migration end determination means determines an intensity of a signal peak corresponding to each component in the sample detected by the detector and determines that the migration of the sample in the capillary is ended when the determined intensity is lower than a predetermined value. Patent Literature 2 states that, by providing such a configuration, when a gel serving as an electrical separation medium is repeatedly used for a plurality of analyses without being replaced, it is possible to calculate a start time of second and subsequent measurements without excess or deficiency. Patent Literature 2 also states that, by providing such a configuration, it is possible to avoid the risk of simultaneously introduction of a plurality of samples into the capillary and an unnecessarily long migration time, which allows a plurality of precise analyses in a minimum amount of time.

Patent Literature 3 discloses a method of performing electrophoresis, which includes the steps of sequentially injecting a next sample into an injection end of a capillary electrophoresis gel at a time n (T_{S}−T_{F}) and performing electrophoresis on the next sample such that a polynucleotide having a lowest electrophoretic mobility in the immediately preceding sample passes through a detection window of an electrophoretic system before a polynucleotide having a highest electrophoretic mobility in the next sample passes through the detection window. Patent Literature 3 states that, by providing such a configuration, in a representative embodiment, a total of up to about 25 migration runs are performed on the same capillary electrophoresis gel such that the same capillary polyacrylamide gel is used for electrophoresis of all samples without rinsing or replacing the capillary gel.

### CITATION LIST

### Patent Literature

Patent Literature 1: Japanese Unexamined Patent Application Publication No. 2004-191247
Patent Literature 2: Japanese Unexamined Patent Application Publication 2000-314720
Patent Literature 3: Japanese Unexamined Patent Application Publication (Translation of PCT Application) No. 2006-504099

### Nonpatent Literature

Nonpatent Literature 1: J. Braz. Chem. Soc., Vol. 15, No. 3, 413-420, 2004
Nonpatent Literature 2: J Forensic Sci. 2005 July; 50 (4):842-8.
Nonpatent Literature 3: J Chromatogr A. 1998 May 8; 806(1 ):157-64.
Nonpatent Literature 4: J Applied Polymer. 2010 January, 48994

### SUMMARY OF INVENTION

### Technical Problem

In [0008] in Patent Literature 1, there is a state that “electrophoretic analysis can repeatedly be performed using the same gel”, but there is no statement that the pre-run mentioned above is performed. Likewise, in [0017] in Patent Literature 3, there are a statement that “the same capillary polyacrylamide gel is used for electrophoresis of all samples” and a statement that “electrophoresis is sequentially performed with the same capillary electrophoresis gel without rising or replacing the capillary gel”, but there is no statement that the pre-run mentioned above is performed.

Meanwhile, in Patent Literature 2, a description has been given of preliminary migration (pre-run) in [0020], a description has been given of sample introduction in [0022], and a description has been given of electrophoresis in [0024]. In addition, in [0026] in Patent Literature 2, it is stated that, after analysis is ended, sample introduction and the electrophoresis are performed in the procedure described above. Note that, in [0020] in Patent Literature 2, it is stated that, in the preliminary migration, a standard sample and an analysis sample are not introduced into the capillary. However, Patent Literature 2 has not clarified whether or not the procedure described above includes filling with the gel and the preliminary migration. In addition, in Patent Literature 2, the timing at which the gel filling is to be performed is not clarified in the description of the overall operation in [0020] and subsequent paragraphs.

Furthermore, each of the inventions described in Patent Literatures 1 to 3 uses the gel as the separation medium, and there is no description or suggestive description of a configuration when a liquid polymer is used as the separation medium. Consequently, while the inventions described in Patent Literatures 1 to 3 have been proposed, the situation is such that a task to reduce the running costs of analysis when a liquid polymer is used as a separation medium has not been accomplished yet.

The present invention has been achieved in view of the circumstances described above. A task of the present invention is to provide a method for continuously using a separation medium that can reduce the running costs of analysis when a liquid polymer is used as a separation medium.

### Solution to Problem

A method for continuously using a separation medium in which the above described problem is solved includes: a separation medium filling step of filling a capillary with the separation medium; a first pre-run step of applying a voltage to the capillary filled with the separation medium to perform a pre-run; a first sample injection step of injecting a first-time sample into the capillary subjected to the pre-run; a first electrophoretic step of applying a voltage to the capillary into which the first-time sample has been injected to perform first electrophoresis; a second pre-run step of applying a voltage to the capillary after the first electrophoretic step to perform a pre-run; a second sample injection step of injecting a next-time sample into the capillary subjected to the second pre-run step; and a second electrophoretic step of applying a voltage to the capillary into which the next-time sample has been injected to perform next electrophoresis. The method repeatedly performs the second pre-run step, the second sample injection step, and the second electrophoretic step a preliminarily set number of times.

### Advantageous Effects of Invention

According to the present invention, it is possible to provide a method for continuously using a separation medium that can reduce the running costs of analysis when a liquid polymer is used as a separation medium. Objects, configurations, and effects other than the above will be apparent from the description of the following embodiments.

### BRIEF DESCRIPTION OF DRAWINGS

FIG. 1 is a configuration overview diagram illustrating a configuration of an electrophoretic device to which a method for continuously using a separation medium according to an embodiment of the present invention is applicable.

FIG. 2 is a top overview diagram illustrating the configuration of the electrophoretic device to which the method for continuously using a separation medium according to the embodiment of the present invention is applicable.

FIG. 3A is a cross-sectional view along IIIa-IIIa in FIG. 2.

FIG. 3B is an enlarged view of an IIIb portion in FIG. 3A.

FIG. 4 is an overview diagram illustrating a control configuration of the electrophoretic device to which the method for continuously using a separation medium according to the embodiment of the present invention is applicable.

FIG. 5 is a flow chart illustrating details of a method for continuously using a separation medium according to a first embodiment of the present invention.

FIG. 6 is a schematic diagram illustrating an example of a graphical user interface (GUI) for setting a separation medium filling frequency in a separation medium filling step.

FIG. 7 is a flow chart illustrating, with regard to the method for continuously using a separation medium according to the first embodiment of the present invention, processing in a micro-controller after a user input the separation medium filling frequency via an input/output device, electrophoresis, and the like.

FIG. 8 is a flow chart illustrating details of a conventional method for filling with a separation medium for each analysis.

FIG. 9 is a flow chart illustrating details of a method for continuously using a separation medium according to a second embodiment of the present invention.

FIG. 10 is a flow chart illustrating, with regard to the method for continuously using a separation medium according to the second embodiment of the present invention, processing in the micro-controller after the user input the separation medium filling frequency via the input/output device, electrophoresis, and the like.

FIG. 11 is an illustrative view illustrating a DNA base sequence around 400 bp and waveform data in each of a first run (1st), a third run (3rd), and an eighth run (8th) in Example 1.

FIG. 12 is an illustrative view illustrating a DNA base sequence and waveform data around 600 bp in each of the first run (1st), the third run (3rd), and the eighth run (8th) in Example 1.

FIG. 13 is a graph illustrating statistical values of respective contiguous read lengths (CRL) in individual sample injection numbers (Injection IDs), i.e., the first to sixth runs in each of Example 1 and Example 2.

FIG. 14 is a graph showing, for comparison, total CRL statistical values in the first to sixth sample injection numbers (up to Injection 6) in Example 1 and Example 2.

FIG. 15 is a graph continuously illustrating transitions of the CRL in DNA sequence analysis in the 1 to 16 sample injection numbers (Injection IDs), i.e., in the first to sixteenth DNA sequence analyses in Example 4.

FIG. 16 is a graph continuously illustrating transitions of EQ in fragment analysis in the 1 to 12 sample injection numbers (Injection IDs), i.e., in the first to twelfth runs in Example 4.

FIG. 17 is an illustrative view illustrating a second-run analysis time difference between each of Examples 1 and 3 in which a pre-run is performed for each run and each of Examples 2 and 4 in which a pre-run is performed only when the first run is performed after liquid polymer filling and no pre-run is performed in each of the second and subsequent runs in comparison to each other.

FIG. 18 is a table showing respective run times in the first to tenth runs in four capillaries (Cap1 to Cap4) and the like in Example 4.

### DESCRIPTION OF EMBODIMENTS

Referring to the drawings as appropriate, a detailed description will be given below of a method for continuously using a separation medium (which may be hereinbelow referred to simply as the “present usage method”) according to an embodiment of the present invention. Note that, in the description of the embodiment, substantially the same or similar components are denoted by the same reference sign and duplicate descriptions thereof may be omitted.

### Electrophoretic Device

Before a description will be given of the present usage method, a description will be given of an electrophoretic device to which the present usage method is applicable.

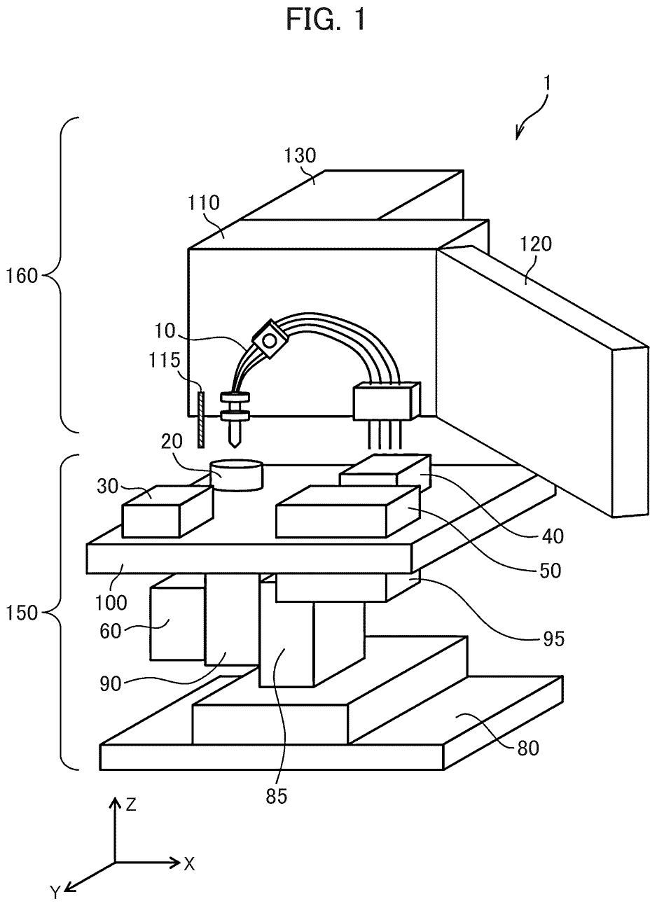

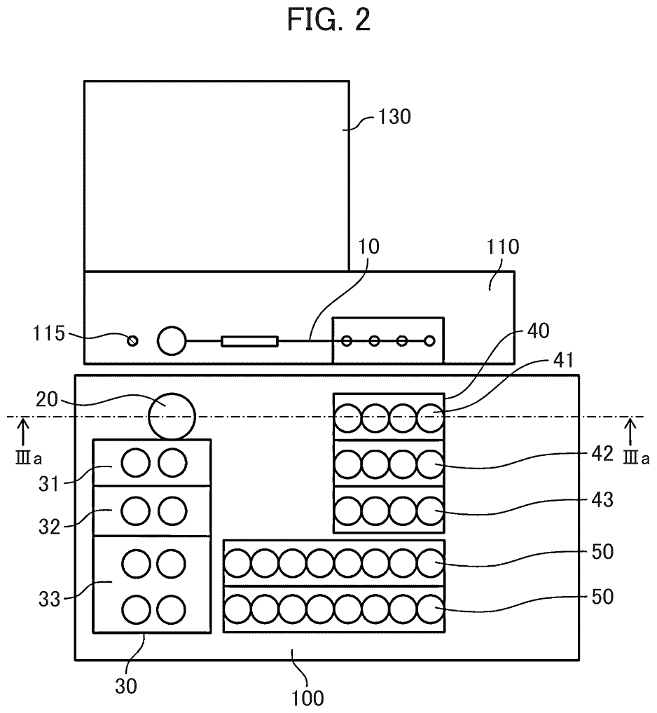

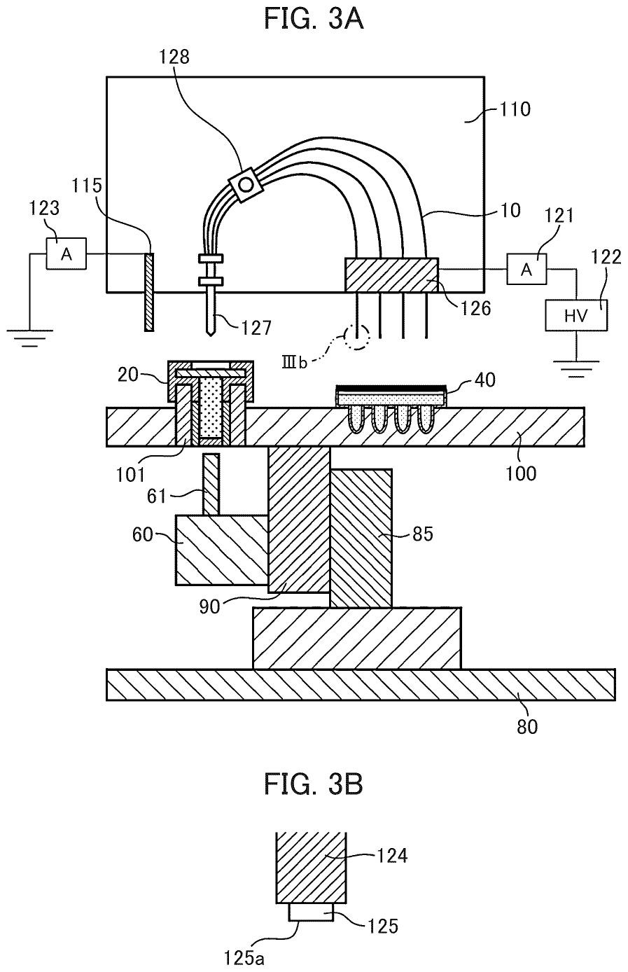

FIG. 1 is a configuration overview diagram illustrating a configuration of an electrophoretic device 1 to which the present usage method is applicable. FIG. 2 is a top overview diagram illustrating the configuration of the electrophoretic device 1 to which the present usage method is applicable. FIG. 3A is a cross sectional view along IIIa-IIIa in FIG. 2. FIG. 3B is an enlarged view of an IIIb portion in FIG. 3A. FIG. is an overview diagram illustrating a control configuration of the electrophoretic device 1 to which the present usage method is applicable.

As illustrated in FIG. 1, the electrophoretic device 1 to which the present usage method is applicable (which may be hereinbelow referred to simply as the “present device 1”) can be roughly divided into two units that are an auto sampler unit 150 located in a device lower portion and an irradiation detection/thermostatic bath unit 160 located in a device upper portion.

In the auto sampler unit 150, a Y-axis driver 85 is mounted on a sampler base 80 to be able to perform Y-axis driving. On the Y-axis driver 85, a Z-axis driver 90 is mounted to be able to perform Z-axis driving. On the Z-axis driver 90, a sample tray 100 is mounted. As illustrated in FIGS. 1 and 2, onto the sample tray 100, a user sets a separation medium container 20, an anode-side buffer container 30, a cathode-side buffer container 40, and a sample container 50. The sample container 50 is set onto an X-axis driver 95 mounted on the sample tray 100 and, on the sample tray 100, only the sample container 50 can be driven along an X-axis. On the Z-axis driver 90, a liquid feeding mechanism 60 is also mounted. The liquid feeding mechanism 60 is placed below the separation medium container 20.

As illustrated in FIG. 1, the irradiation detection/thermostatic bath unit 160 has a thermostatic bath unit 110 and a thermostatic bath door 120 to allow a constant temperature to be maintained therein. Behind the thermostatic bath unit 110, an irradiation detection unit 130 is mounted to be able to perform detection during electrophoresis. In the thermostatic bath unit 110, the user sets a capillary array 10 obtained by assembling a plurality of capillaries 125 (see FIG. 3B), the electrophoresis is performed in the thermostatic bath unit 110, while the capillary array 10 is maintained at a constant temperature, and the irradiation detection unit 130 performs detection. In addition, in the thermostatic bath unit 110, an electrode 115 for dropping a high voltage to GND during high voltage application for the electrophoresis is also mounted.

As illustrated in FIG. 3A, the capillary array 10 includes a load header 126, a capillary head 127, a detection unit 128, and the like. The load header 126 is attached to one end portion of the capillary array 10. The load header 126 serves as a cathode-side end portion of the capillary array 10.

The capillary head 127 is attached to another end portion of the capillary array 10. The capillary head 127 is a bundled pressure-tight and is a detachable member in which the capillaries 125 are bundled together in a pressure-tight manner. The capillary head 127 corresponds to an anode-side end portion of the capillary array 10.

Inside the detection unit 128, the capillaries 125 are planarly arranged at given intervals. The irradiation detection unit 130 irradiates the capillaries 125 arranged in the detection unit 128 with light. Then, the detection unit 128 detects fluorescence generated from a sample electrophoresed in each of the capillaries 125 by the light irradiation or the like.

As described above, the capillary array 10 is set in the thermostatic bath unit 110. The separation medium container 20, the anode-side buffer container 30, the cathode-side buffer container 40, and the sample container 50 can be driven along the Y-Z axes by the auto sampler unit 150, and only the sample container 50 can further be driven along the X-axis. To the set capillary array 10, the separation medium container 20, the anode-side buffer container 30, the cathode-side buffer container 40, and the sample container 50 can automatically be connected at optional positions by movement of the auto sampler unit 150.

As illustrated in FIG. 2, the anode-side buffer container 30 set on the sample tray 100 includes an anode-side cleaning tank 31, an anode-side electrophoretic buffer tank 32, and a sample introduction buffer tank 33. Meanwhile, the cathode-side buffer container 40 includes a waste liquid tank 41, a cathode-side cleaning tank 42, and a cathode-side electrophoretic buffer tank 43.

The separation medium container 20, the anode-side buffer container 30, the cathode-side buffer container 40, and the sample container 50 are placed in positional relationships as illustrated in FIG. 2. In other words, the anode-side buffer container 30 is placed in a front side (side on which the thermostatic bath door 120 is opened/closed) and a left side of the device on the sample tray 100. The separation medium container 20 is placed behind the anode-side buffer container 30. The sample container 50 is placed on the front side and a right side of the device on the sample tray 100. The cathode-side buffer container 40 is placed behind the sample container 50. Thus, a positional relationship between the anode side and the cathode side at the time of connection to the capillary array 10 is satisfied by a “separation medium container 20—waste liquid tank 41” pair, an “anode-side cleaning tank 31—cathode-side cleaning tank 42” pair, an “anode-side electrophoretic buffer tank 32—cathode-side electrophoretic buffer tank 43” pair, and a “sample introduction buffer tank 33—sample container 50” pair.

As illustrated in FIG. 3A, the separation medium container 20 is inserted and set in a guide 101 embedded in the sample tray 100. The separation medium container 20 contains the separation medium. As the separation medium, for example, a liquid polymer is preferably used. This allows the liquid feeding mechanism 60 in the present device 1 to appropriately and automatically fill the capillaries 125 (see FIG. 3B) with the separation medium and discharge the separation medium from the capillaries 125. The liquid feeding mechanism 60 is disposed such that a plunger 61 embedded in the liquid feeding mechanism 60 is located below the separation medium container 20. The plunger 61 pushes a cylinder (not shown) provided in the separation medium container 20 upward to allow the separation medium (not shown) in the separation medium container 20 to be introduced into the capillaries 125 via the capillary head 127.

At the time of electrophoresis, a left side of the capillary array 10 in FIG. 3A serves as an anode side, while a right side thereof serves as a cathode side. The auto sample unit 150 moves to a position of the “anode-side electrophoretic buffer tank 32—cathode-side electrophoretic buffer tank 43” pair, and a high voltage is applied to the capillary array 10 on the cathode side and caused by the electrode 115 to flow to GND via the cathode-side buffer container 40 and the anode-side buffer container 30 and thereby cause electrophoresis.

As illustrated in FIG. 3B, the individual capillaries 125 included in the capillary array 10 are fixed through respective hollow electrodes 124 made of metal. Note that each of the hollow electrodes 124 is provided over a portion (from the cathode-side end portion to the load header 126) of the capillary 125.

As illustrated in FIG. 3B, a leading end 125a of the capillary 125 is in a state protruding by about 0.5 mm from the hollow electrode 124. Note that a length of the capillary 125 protruding from the hollow electrode 124 is not limited to 0.5 mm. In addition, all the hollow electrodes 124 provided over the respective capillaries 125 are attached in an integrated state to the load header 126 (see FIG. 3A). All the hollow electrodes 124 are connected to a high-voltage power source 122 via the load header 126. Since the high-voltage power source 122 applies a negative voltage to the hollow electrodes 124, each of the hollow electrodes 124 operates as a cathode electrode when a voltage is applied to the hollow electrode 124 such as during electrophoresis or during sample injection.

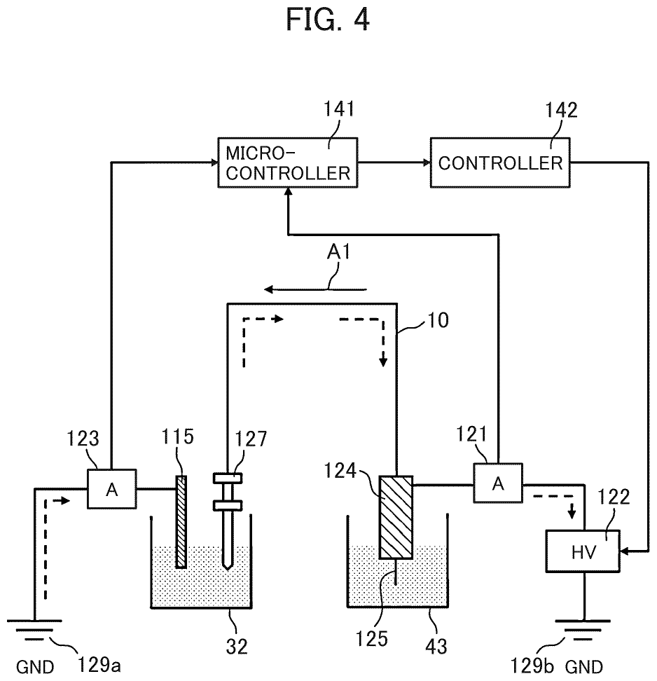

As illustrated in FIG. 4, a voltage control mechanism includes a micro-controller (micon) 141, a controller 142, the high-voltage power source 122, a first current meter 121, and a second current meter 123.

The micro-controller 141 uses the separation medium with which the capillary array 10 is filled to check an energized state of each of the anode-side electrophoretic buffer tank 32 and the cathode-side electrophoretic buffer tank 43. Then, the micro-controller 141 outputs a result of the checked energized state to an input/output device (not shown). The input/output device is formed of, e.g., a touch panel or the like.

The controller 142 controls voltage application to a conductive path resulting from control of the high-voltage power source 122, movement of the sample tray 100, movement of the sample container 50 by the X-axis driver 95, and the like.

The high-voltage power source 122 applies the voltage to the conductive path on the basis of the control by the controller 142. The conductive path includes the hollow electrodes 124, the electrophoretic buffer filling the cathode-side electrophoretic buffer tank 43 (which may alternatively be the sample in the sample container 50), the electrophoretic buffer filling the anode-side electrophoretic buffer tank 32 (which may alternatively be the buffer filling the sample introduction buffer tank 33), and the electrode 115. More specifically, since the high-voltage power source 122 generates the voltage (negative voltage) lower than those from the GNDs 129a and 129b, a flow of a current when the negative voltage is applied from the high-voltage power source 122 becomes a flow indicated by each of broken-line arrows in FIG. 4. In other words, the current flows from the GND 129a to the high-voltage power source 122, while passing through the second current meter 123, the electrode 115, the capillary array 10, the hollow electrodes 124, and the first current meter 121 in this order. Therefore, the conductive path extends from the GND 129a to the high-voltage power source 122, while passing through the second current meter 123, the electrode 115, the capillary array 10, the hollow electrodes 124, and the first current meter 121.

The high-voltage power source 122 is electrically conducted to the hollow electrodes 124 via the first current meter 121, while being electrically conducted to the electrode 115 via the second current meter 123. To the both ends thereof, a voltage of several tens of kilovolts is applied to cause the hollow electrodes 124 to generate an electric field in a direction of the electrode 115. Due to the electric field, a negatively charged sample such as a nucleic acid moves from the cathode-side leading end 125a (see FIG. 3B) of each of the capillaries 125 to the detection unit 128 (see FIG. 3A). Thus, the sample (e.g., DNA) having negative charge is electrophoresed in a direction of an arrow A1 in FIG. 4.

At this time, the first current meter 121 detects a current flowing from the high-voltage power source 122 to each of the hollow electrodes 124 and transmits a current value thereof to the micro-controller 141. Meanwhile, the second current meter 123 detects a current flowing from the electrode 115 to the GND 129a and transmits a current value thereof to the micro-controller 141. To check the current values and fluctuations thereof, the second current meter 123 is normally used. The reason for this is that the second current meter 123 more directly reflects a value of a current flowing in an electrophoretic path. When there is current leakage between the first current meter 121 and the second current meter 123, a value indicated by the first current meter 121 also includes a current value of a leaked current, while a numerical value indicated by the second current meter 123 does not include the current value of the leaked current. In other words, a net amount of the current flowing in the electrophoretic path is detected. Between the first current meter 121 and the second current meter 123, a portion in which a medium having a relatively high resistance compared to that of metal, such as a buffer and a separation medium (e.g., liquid polymer) is present is interposed, and a large number of connecting portions such as blocks and the capillaries 125 are further present. Therefore, it can be said that a circuit passing through the first current meter 121 is a portion where current leakage is likely to occur.

### Method for Continuously Using Separation Medium

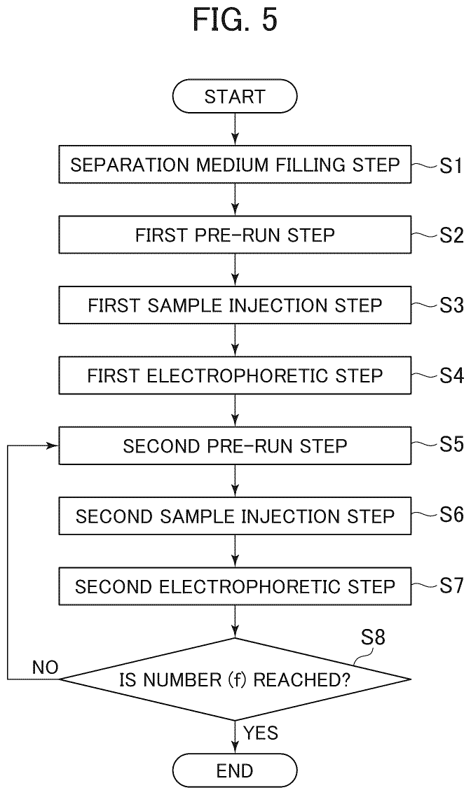

Next, a description will be given of the present usage method. FIG. 5 is a flow chart illustrating details of a method for continuously using a separation medium according to a first embodiment of the present invention.

The present usage method is applied to the electrophoretic device 1.

### First Embodiment

As illustrated in FIG. 5, the present usage method according to the first embodiment includes a separation medium filling step S1, a first pre-run step S2, a first sample injection step S3, a first electrophoretic step S4, a second pre-run step S5, a second sample injection step S6, and a second electrophoretic step S7.

The present usage method repeatedly performs the second pre-run step S5 described above, the second sample injection step S6 described above, and the second electrophoretic step S7 described above a preliminarily set number (n) of times.

The separation medium filling step S1 is a step of filling the capillaries 125 with the separation medium. The filling of the capillaries 125 with the separation medium can be performed by the liquid feeding mechanism 60 described above.

The first pre-run step S2 is a step of applying a voltage to the capillaries 125 filled with the separation medium described above to perform a pre-run. The pre-run is voltage application to the separation medium prior to electrophoresis of the sample. By performing the pre-run, it is possible to remove impurities in the separation medium and prepare a separation medium environment optimum for analysis. The pre-run is performed without injecting the sample. The first pre-run step S2 can be performed by appropriately driving the sample tray 100 along the X-axis, the Y-axis, and the Z-axis such that the positional relationship between the anode side and the cathode side in connection to the capillary array 10 is satisfied by the “anode-side electrophoretic buffer tank 32—cathode-side electrophoretic buffer tank 43” pair, and applying the voltage. The first pre-run step S2 can be performed under a typical combination of conditions such as, e.g., 60° C., 3 minutes, and 15 kV.

The first sample injection step S3 is a step of injecting a first-time sample into the capillaries 125 subjected to the pre-dun described above. The first sample injection step S3 can be performed by appropriately driving the sample tray 100 along the X-axis, the Y-axis, and the Z-axis such that the positional relationship between the anode side and the cathode side in connection to the capillary array 10 is satisfied by the “sample introduction buffer tank 33—sample container 50” pair, and applying the voltage. The first sample injection step S3 can be performed under, e.g., 60° C., 4 minutes, and 1.2 kV.

The first electrophoretic step S4 is a step of applying a voltage to the capillaries 125 into which the first-time sample has been injected, to perform first electrophoresis. The first electrophoretic step S4 can be performed by appropriately driving the sample tray 100 along the X-axis, the Y-axis, and the Z-axis such that the positional relationship between the anode side and the cathode side in connection to the capillary array 10 is satisfied by the “anode-side electrophoretic buffer tank 32—cathode-side electrophoretic buffer tank 43” pair, and applying the voltage. The first electrophoretic step S4 can be performed under, e.g., 60° C., 30 minutes, and 7.5 kV.

The second pre-run step S5 is a step of applying a voltage to the capillaries 125 after the first electrophoretic step S4 described above and performing a pre-run. In other words, in the present usage method, discarding of the separation medium in the capillaries 125 and reinjection of the separation medium into the capillaries 125 (i.e., replacement of the separation medium), which is normally performed after analysis is performed with the previous electrophoresis (run), is not performed, and a pre-run for a next sample analysis (second pre-run step S5) is performed using the same separation medium as used in the previous run. Note that a run means electrophoresis of the sample added to the separation medium in the capillaries 125, which is caused by a potential difference produced by the high-voltage power source 122 between both ends of each of the capillaries 125. During the run, sample detection is performed by the irradiation detection unit 130.

The second sample injection step S6 is a step of injecting a next-time sample into the capillaries 125 subjected to the second pre-run step S5 described above. The second sample injection step S6 can be performed similarly to the first sample injection step S3.

The second electrophoretic step S7 is a step of applying a voltage to the capillaries 125 into which the next-time sample has been injected, to perform next electrophoresis. The second electrophoretic step S7 can be performed similarly to the first electrophoretic step S4.

Then, as described above, the present usage method repeatedly performs the second pre-run step S5, the second sample injection step S6, and the second electrophoretic step S7 the preliminarily set number (n) of times. After repeatedly performing a sequence of the second pre-run step S5, the second sample injection step S6, and the second electrophoretic step S7 the preliminarily set number of times, the present usage method ends the analysis using one fill of the separation medium supplied in the separation medium filling step S1. Then, the present usage method returns to the separation medium filling step S1 to replace the separation medium in the capillaries 125 and perform each of the steps including and subsequent to the first pre-run step S2 by using a new separation medium exactly as described above. The present usage method performs this an intended number of times.

The separation medium filling frequency (f) in the present description refers to filling with a new separation medium (separation medium refilling frequency) every time the total number of a plurality of runs performed with one fill of the separation medium reaches a predetermined number (f). In other words, the separation medium filling frequency (f) means the total number of runs in the first electrophoretic step S4 performed once and the second electrophoretic step S7 repeatedly performed n times each with one fill of the separation medium. That is, f=1+n is satisfied. In other words, the number (n) of times the second pre-run step S5, the second sample injection step S6, and the second electrophoretic step S7 are to be repeatedly performed can be calculated and set on the basis of “separation medium filling frequency in separation medium filling step S1−1” (f−1). For example, when the separation medium filling frequency (f) is set to 4, the setting includes a set of one run in the first electrophoretic step S4 and three runs in the second electrophoretic step S7. In a case of thus adopting the present mode, when the separation medium filling frequency (f) is set, the set number (n) of times the second pre-run step S5, the second sample injection step S6, and the second electrophoretic step S7 are to be repeated is thereby set.

Meanwhile, the number (n) of times the second pre-run step S5, the second sample injection step S6, and the second electrophoretic step S7 are to be repeated refers to the number of the second and subsequent runs performed using the separation medium used in the first run.

As described above, in the present usage method, one fill of the separation medium is used in the plurality of runs. Therefore, the present usage method can reduce a filling frequency of the separation medium which is most costly among reagents required for capillary sequence analysis, e.g., the liquid polymer, and thereby reduce the running costs of the analysis.

It is to be noted herein that, in the present embodiment, the number (n) of times the second pre-run step S5, the second sample injection step S6, and the second electrophoretic step S7 are to be repeated can also be set optionally by the user. The set number of times these steps are to be repeated (i.e., the number of times the run in the second electrophoretic step S7 is to be repeated) can be set to, e.g., 1, 2, 3, 4, 5, 6, 7, 8, 9, 10, 11, 12, 13, 14, 15, 16, 17, 18, 19, 20, 21, 22, 23, 24, 25, or the like, but may also be 26 or more. Since the one run is performed in the first electrophoretic step S4, when the set number of times the run is to be repeated is, e.g., 5, the total of 6 runs are performed with one fill of the separation medium. Thus, in the present mode, by preliminarily setting the number (n) of times the second pre-run step S5, the second sample injection step S6, and the second electrophoretic step S7 are to be repeated, it is possible to perform the one run in the first electrophoretic step S4 and optionally set n runs in the second electrophoretic step S7 in one set with one fill of the separation medium.

Note that the set number (n) of times the steps described above are to be repeated can optionally be set depending on the condition of the sample, such as the state of degradation of the separation medium or a length of a DNA strand. When the DNA strand has a length of, e. g., about 300 bp, the set number of times can be 4 to 5 (the total of 5 to 6 runs, i.e., the separation medium filling frequency of 5 to 6) or the like with one fill of the separation medium. Alternatively, when the DNA strand has a length of, e. g., about 600 bp, the set number of times can be 3 (the total of 4 runs, i.e., the separation medium filling frequency of 4) or the like with one fill of the separation medium.

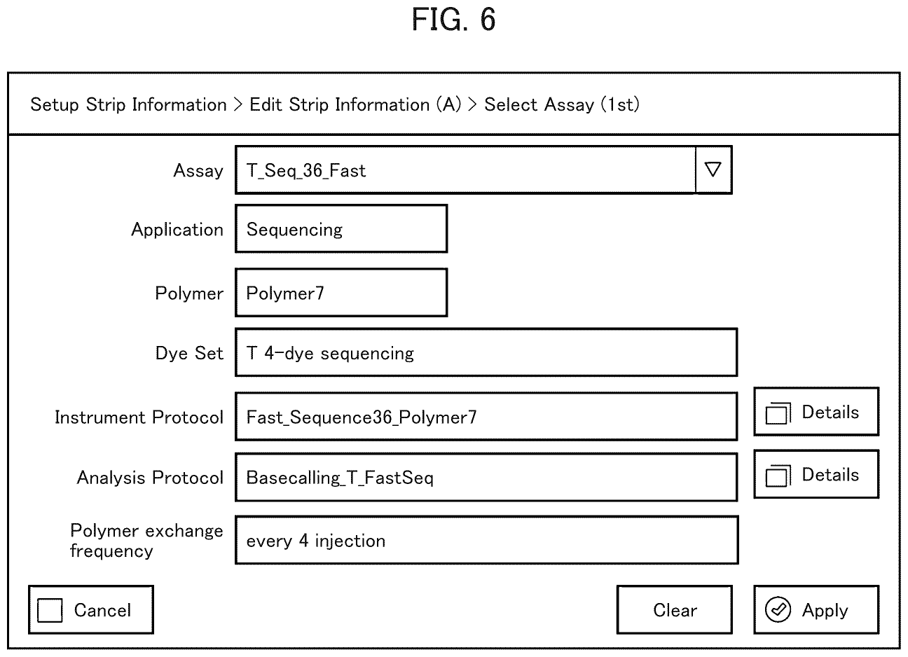

The separation medium filling frequency (f) in the separation medium filling step S1 can be input via, e.g., the input/output device (not shown) connected to the micro-controller 141. FIG. 6 is a schematic diagram illustrating an example of the graphical user interface (GUI) for setting the separation medium filling frequency in the separation medium filling step S1. As illustrated in FIG. 6, the input/output device can display the GUI for inputting the separation medium filling frequency (f).

By inputting, e.g., “every 4 injection”, “4”, or the like to “Polymer exchange frequency” in a lower field of the GUI illustrated in FIG. 6 or selecting a radio button “4”, the user can set the separation medium filling frequency to 4.

The set number (n) of times the steps described above are to be repeated can also be input similarly to the separation medium filling frequency (f), though not illustrated in FIG. 6. For example, the GUI for inputting the set number (n) of times the steps described above are to be repeated may appropriately be displayed on the input/output device described above. To input the set number (n) of times the steps described above are to be repeated, a “Number of repetitions of 2nd electrophoresis” field is provided in the GUI and, by inputting, e.g., “3 times”, “3”, or the like to this field or selecting a radio button “3”, it is possible to set the set number of times the steps described above are to be repeated to 3.

In the present usage method, when the separation medium filling frequency reaches the preliminarily set number (f), i.e., when the total number of runs reaches f (i.e., when the set number (n) of times the steps described above are to be repeated, which is calculated and set to (f−1), is reached) (Yes in Step S8 in FIG. 5), all the analyses (runs) performed with one fill of the separation medium are ended. Then, the present usage method returns to the separation medium filling step S1 to replace the separation medium in the capillaries 125 and perform each of the steps including and subsequent to the first pre-run step S2 by using a new separation medium exactly as described above.

Meanwhile, when the frequency in the separation medium filling step S1 has not reached the preliminarily set number (f), i.e., when the total number of runs has not reached f (i.e., the set number (n) of times the steps described above are to be repeated, which is calculated and set to (f−1), is not reached) (No in Step S8 in FIG. 5), the present usage method returns to the second pre-run step S5 to perform the second pre-run step S5, the second sample injection step S6, and the second electrophoretic step S7.

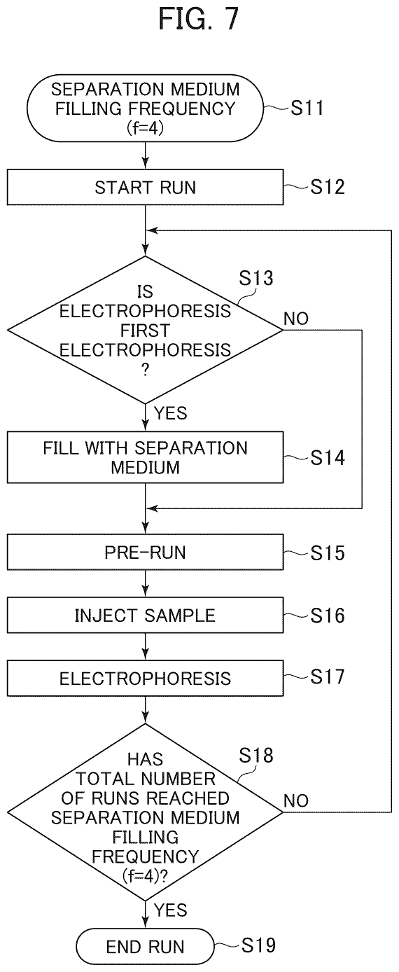

FIG. 7 is a flow chart illustrating, with regard to the method for continuously using the separation medium according to the first embodiment of the present invention, processing in the micro-controller 141 after the user input the separation medium filling frequency via the input/output device, electrophoresis, and the like. As illustrated in FIG. 7, the user inputs the separation medium filling frequency (Step S11). In the example in FIG. 7, e.g., “4” is input as the separation medium filling frequency. As a result, when the total number of runs has reached 4, the micro-controller 141 is set to discard the used separation medium from the capillaries 125 and fill the capillaries 125 with a new separating medium. In addition, in the micro-controller 141, “separation medium filling frequency−1” is calculated, and the set number of times the steps described above are to be repeated is set (n=3).

Then, when the user inputs a key to start a run, analysis is started (Step S12). The micro-controller 141 determines whether or not electrophoresis is first electrophoresis (Step S13). When the electrophoresis is first electrophoresis (Yes in Step S13), the micro-controller 141 gives an instruction to perform the separation medium filling (Step S14), and the present device 1 performs the separation medium filling step S1.

Then, the micro-controller 141 gives an instruction to perform a pre-run (Step S15), and the present device 1 performs the first pre-run step S2.

Then, the micro-controller 141 gives an instruction to perform sample injection (Step S16), and the present device 1 performs the first sample injection step S3.

Then, the micro-controller 141 gives an instruction to perform electrophoresis (Step S17), and the present device 1 performs the first electrophoretic step S4.

After the electrophoresis is ended, the micro-controller 141 determines whether or not the total number of runs has reached the input separation medium filling frequency (f=4) (Step S18). When the total number of runs has not reached the separation medium filling frequency (f=4) (No in Step S18), the micro-controller 141 returns to immediately after the inputting of the key to start a run, to determine whether or not electrophoresis to be performed next is first electrophoresis (Step S13).

Since the electrophoresis to be performed next is not first electrophoresis (No in Step S13), the micro-controller 141 gives an instruction to perform a pre-run (Step S15), and the present device 1 performs the second pre-run step S5.

Then, the micro-controller 141 gives an instruction to perform sample injection (Step S16), and the present device 1 performs the second sample injection step S6.

Then, the micro-controller 141 gives an instruction to perform electrophoresis (Step S17), and the present device 1 performs the second electrophoretic step S7.

After the electrophoresis is ended, the micro-controller 141 determines whether or not the total number of runs has reached the input separation medium filling frequency (f=4) (Step S18). When the total number of runs has not reached the separation medium filling frequency (f=4) (No in Step S18), the micro-controller 141 returns again to immediately after the inputting of the key to start a run, to determine whether or not electrophoresis to be performed next is first electrophoresis (Yes or No in Step S13) and give the instruction described above to the present device 1 (advances to Step S14 or Step S15).

When the total number of runs has reached the separation medium filling frequency (f=4) (Yes in Step S18), the micro-controller 141 gives an instruction to end the run to the present device 1 (Step S19), and the present device 1 ends the run.

The micro-controller 141 performs the sequential flow described above and illustrated in FIG. 7 the number of times set by the user to analyze the sample.

Thus, when electrophoresis is not first electrophoresis at the set separation medium filling frequency, the present usage method does not perform the separation medium filling. Therefore, the present usage method can reduce a filling frequency of the separation medium which is most costly among reagents required for capillary sequence analysis, e. g., the liquid polymer and thereby reduce the running costs of the analysis.

Here, the present usage method will be compared to the conventional method of performing the separation medium filling for each analysis.

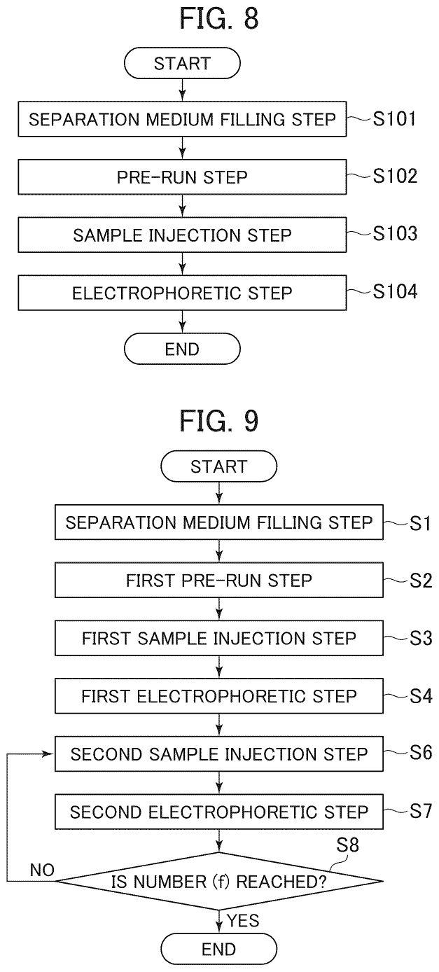

FIG. 8 is a flow chart illustrating details of the conventional method of performing the separation medium filling for each analysis.

As illustrated in FIG. 8, the conventional method includes a separation medium filling step S101, a pre-run step S102, a sample injection step S103, and a electrophoretic step S104.

These steps in the conventional method illustrated in FIG. 8 respectively correspond to the separation medium filling step S1, the first pre-run step S2, the first sample injection step S3, and the first electrophoretic step S4 in the present usage method illustrated in FIG. 5.

The conventional method illustrated in FIG. 8 performs the separation medium filling for each analysis, and therefore performs these steps each time. In other words, the conventional method illustrated in FIG. 8 does not include the second pre-run step S5, the second sample injection step S6, and the second electrophoretic step S7 in the present usage method illustrated in FG. 5, and does not repeatedly perform these steps. Accordingly, in the conventional method, the filling frequency of the separation medium, which is most costly among the reagents required for the capillary sequence analysis, is not reduced, and the running costs of analysis remain high.

As a result of conducting study to solve the problem of the present invention, the present inventors have repeatedly performed the second pre-run step S5, the second sample injection step S6, and the second electrophoretic step S7 the preliminarily set number of times in the present usage method according to the first embodiment. The present inventors have found that analysis performance thus obtained has waveform data which is slightly inferior, but sufficiently satisfies specifications, as will be described later. The present inventors have also found that, in the present usage method according to the first embodiment, a turn around time (TAT) has improved compared to that in the conventional method illustrated in FIG. 8.

### Second Embodiment

Next, a description will be given of the present usage method according to a second embodiment. FIG. 9 is a flow chart illustrating details of a method for continuously using a separation medium according to the second embodiment of the present invention.

As illustrated in FIG. 9, the present usage method according to the second embodiment includes the separation medium filling step S1, the first pre-run step S2, the first sample injection step S3, the first electrophoretic step S4, the second sample injection step S6, and the second electrophoretic step S7.

The present usage method repeatedly performs each of the second sample injection step S6 described above and the second electrophoretic step S7 described above a preliminarily set number (n) of times.

The present usage method according to the second embodiment is different from the present usage method according to the first embodiment including the second pre-run step S5 in that the second pre-run step S5 is not included therein.

In addition, the second sample injection step S6 of the present usage method according to the second embodiment is the step of injecting a next-time sample into the capillaries after the first electrophoretic step S4. By contrast, the second sample injection step S6 in the present usage method according to the first embodiment is the step of injecting the next-time sample into the capillaries subjected to the second pre-run step S5. Thus, the second sample injection step S6 of the present usage method according to the second embodiment and the second sample injection step S6 of the present usage method according to the first embodiment are different in details of the step.

Moreover, the present usage method according to the second embodiment repeatedly performs each of the second sample injection step S6 described above and the second electrophoretic step S7 described above the preliminarily set number (n) of times. By contrast, the present usage method according to the first embodiment repeatedly performs each of the second pre-run step S5 described above, the second sample injection step S6 described above, and the second electrophoretic step S7 described above the preliminarily set number (n) of times. Thus, the present usage method according to the second embodiment and the present usage method according to the first embodiment are different in details of the steps to be repeatedly performed.

The present usage method according to the second embodiment and the present usage method according to the first embodiment have a difference therebetween in that the present usage method according to the second embodiment does not include the second pre-run step S5, but have otherwise the same configuration.

A description will be given below of the present usage method according to the second embodiment with an emphasis on the difference with the present usage method according to the first embodiment.

As described above, the second sample injection step S6 of the present usage method according to the second embodiment is a step of injecting the next-time sample into the capillaries 125 after the first electrophoretic step S4 (without performing a pre-run). As a result of conducting study to solve the problem of the present invention, the present inventors have surprisingly found that, when the next-time sample is injected into the capillaries 125 after the first electrophoretic step S4 and the next electrophoresis is performed without performing a pre-run, i.e., when the second sample injection step S6 and the second electrophoretic step S7 are performed after the first electrophoretic step S4, an increase in the number of analyses, an improvement in turn-around time (TAT), an improvement in analysis performance, and the like can be obtained compared to a case where a pre-run (the second pre-run step S5 in the first embodiment) is performed before the second sample injection step. These effects are achieved because a pre-run was omitted and the degradation of the separation medium was suppressed. Examples of the degradation of the separation medium include decomposition of urea. In other words, the present usage method according to the second embodiment omits the second pre-run step S5 to thereby suppress the decomposition of the urea caused by a pre-run and reduce the action of a decomposition product of urea to inhibit adsorption of a liquid polymer or the like to a glass surface of the separation medium. As a result, an electroosmotic flow is less likely to increase (is suppressed), which improves, e.g., the number of analyses of a sample such as DNA and analysis performance. Moreover, since no pre-run is performed, each of the analyses can be ended earlier. For example, in a typical capillary DNA sequencer, a period of about 30 minutes is required for one analysis, of which about 3 minutes are required for a pre-run. Since the pre-run is omitted in the analysis of the next-time sample, an analysis time can be reduced by about 10%. This can be said to be an advantageous effect compared to effects achieved by the conventional method that performs a pre-run for each analysis and to the present usage method according to the first embodiment.

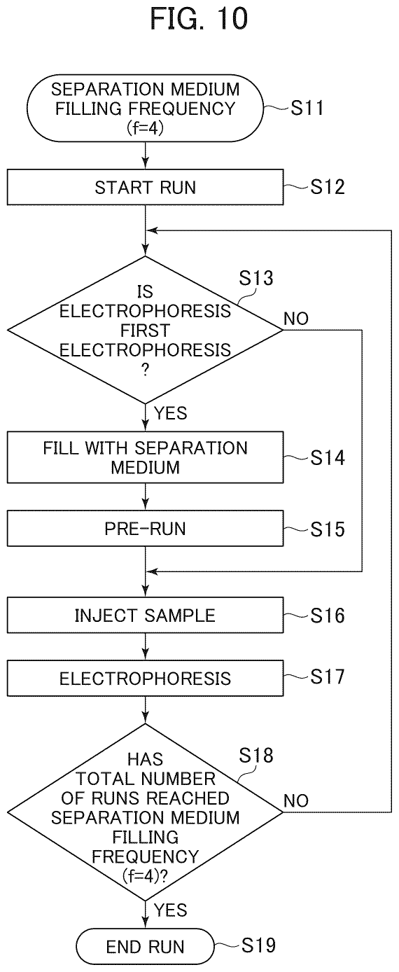

FIG. 10 is a flow chart illustrating, with regard to the method for continuously using the separation medium according to the second embodiment of the present invention, processing in the micro-controller 141 after the user input the separation medium filling frequency via the input/output device, electrophoresis, and the like.

As illustrated in FIG. 10, the user inputs the separation medium filling frequency (step S11). In the example in FIG. 10, “4” is input as the separation medium filling frequency (f=4). As a result, when the total number of runs has reached 4, the micro-controller 141 is set to discard the used separation medium from the capillaries 125 and fill the capillaries 125 with a new separating medium. In addition, in the micro-controller 141, “separation medium filling frequency −1” is calculated, and the set number of times the steps described above are to be repeated is set (n=3).

Then, when the user inputs a key to start a run, analysis is started (Step S12). The micro-controller 141 determines whether or not electrophoresis is first electrophoresis (Step S13). When the electrophoresis is first electrophoresis (Yes in Step S13), the micro-controller 141 gives an instruction to perform the separation medium filling (Step S14), and the present device 1 performs the separation medium filling step S1.

Then, the micro-controller 141 gives an instruction to perform a pre-run (Step S15), and the present device 1 performs the first pre-run step S2.

Then, the micro-controller 141 gives an instruction to perform sample injection (Step S16), and the present device 1 performs the first sample injection step S3.

Then, the micro-controller 141 gives an instruction to perform electrophoresis (Step S17), and the present device 1 performs the first electrophoretic step S4.

After the electrophoresis is ended, the micro-controller 141 determines whether or not the total number of runs has reached the input separation medium filling frequency (f=4) (Step S18). When the total number of runs has not reached the separation medium filling frequency (f=4) (No in Step S18), the micro-controller 141 returns to immediately after the inputting of the key to start a run to determine whether or not electrophoresis to be performed next is first electrophoresis (Step S13).

Since electrophoresis to be performed next is not first electrophoresis (No in Step S13), the micro-controller 141 gives an instruction to perform sample injection (Step S16), and the present device 1 performs the second sample injection step S6.

Then, the micro-controller 141 gives an instruction to perform electrophoresis (Step S17), and the present device 1 performs the second electrophoretic step S7.

After the electrophoresis is ended, the micro-controller 141 determines whether or not the total number of runs has reached the input separation medium filling frequency (f=4) (Step S18). When the total number of runs has not reached the separation medium filling frequency (f=4) (No in Step S18), the micro-controller 141 returns again to immediately after the inputting of the key to start a run to determine whether or not electrophoresis to be performed next is fist electrophoresis (Yes or No in Step S13) and give the instruction described above to the present device 1 (advances to Step S14 or Step S16).

When the total number of runs has reached the separation medium filling frequency (f=4) (Yes in Step S18), the micro-controller 141 gives an instruction to end the run to the present device 1 (Step S19), and the present device 1 ends the run.

The micro-controller 141 performs the sequential flow described above and illustrated in FIG. 10 the number of times set by the user to analyze the sample.

### EXAMPLES

Next, examples of the present usage method will be described.

### [1] Examination 1

### Example 1

Example 1 performed capillary sequence DNA base sequence analysis according to the flow illustrated in FIG. 5 under the following conditions. As a capillary DNA sequencer, DS3000 manufactured by Hitachi High-Tech Corporation was used. As the separation medium, a liquid polymer was used. As the liquid polymer, Spectrum Compact Polymer 7 (CE237A manufactured by Promega Corporation) was used. As a DNA sample to be analyzed, Sequencing Standard, BigDye™ Terminator v3.1 (manufactured by Thermo Fisher Scientific) was used.

### Conditions in Example 1

The separation medium filling step S1 was performed in accordance with a determined method in the capillary DNA sequencer.

The first pre-run step S2 was performed at 60° C., for 3 minutes, and with 15 kV.

The first sample injection step S3 was performed at 60° C., for 4 seconds, and with 1.2 kV.

The first electrophoretic step S4 was performed at 60° C., for 30 minutes, and with 7.5 kV.

The second pre-run step S5 was performed at 60° C., for 3 minutes, and with 15 kV.

The second sample injection step S6 was performed at 60° C., for 4 seconds, and with 1.2 kV.

The second electrophoretic step S7 was performed at 60° C., for 30 minutes, and with 7.5 kV.

Example 1 set the separation medium filling frequency to 8 (i.e., set the set number of times the second pre-run step S5, the second sample injection step S6, and the second electrophoretic step S7 were to be repeated to 7), performed these in one set twice, and performed the total of 16-run analyses.

### Example 2

Example 2 performed capillary sequence DNA base sequence analysis according to the flow illustrated in FIG. 9 under the following conditions. Note that the capillary DNA sequencer, the liquid polymer, and the DNA sample were the same as those in Example 1.

### Conditions in Example 2

The separation medium filling step S1 was performed in accordance with a determined method in the capillary DNA sequencer.

The first pre-run step S2 was performed at 60° C., for 3 minutes, and with 15 kV.

The first sample injection step S3 was performed at 60° C., for 4 seconds, and with 1.2 kV.

The first electrophoretic step S4 was performed at 60° C., for 30 minutes, and with 7.5 kV.

The second sample injection step S6 was performed at 60° C., for 4 seconds, and with 1.2 kV.

The second electrophoretic step S7 was performed at 60° C., for 30 minutes, and with 7.5 kV.

Example 2 also set the separation medium filling frequency to 8 (i.e., set the number of times the second sample injection step S6 and the second electrophoretic step S7 were to be repeated to 7), performed these in one set twice sequentially, and performed the total of 16-run analyses.

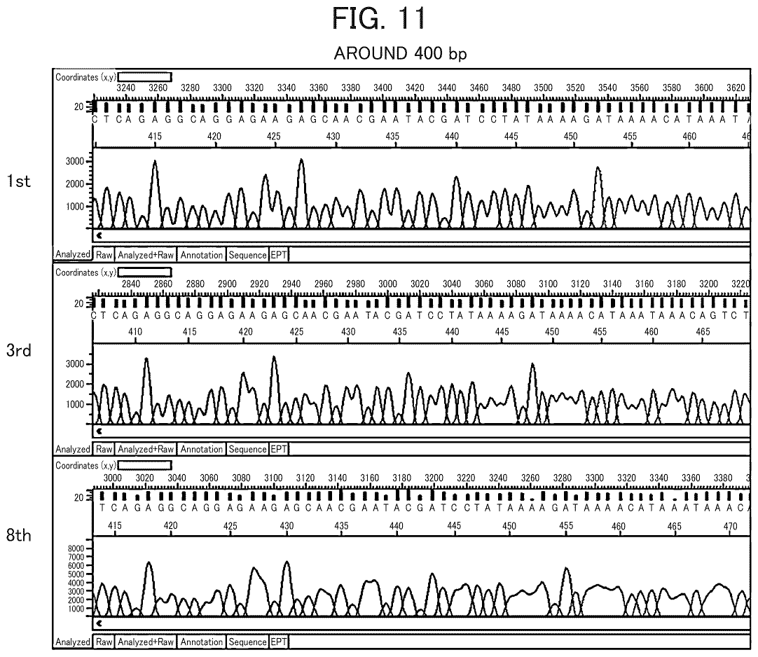

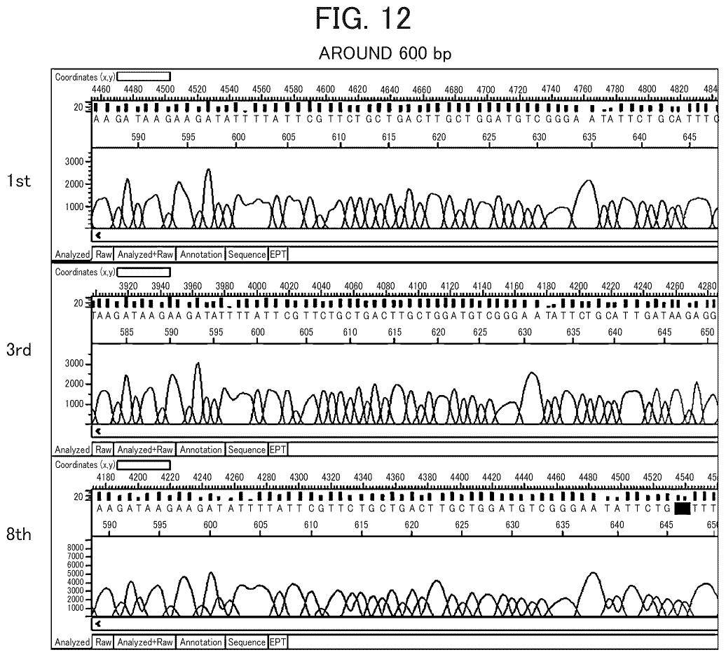

FIG. 11 and FIG. 12 partly illustrate a result of the analysis in Example 1.

FIG. 11 is an illustrative view illustrating DNA base sequences and waveform data in the vicinity of 400 bp in the first run (1st), the third run (3rd), and the eighth run (8th) in Example 1. The first run is first electrophoresis after one fill of the liquid polymer. The third run is third electrophoresis after the one fill of the liquid polymer. The eighth run is eighth electrophoresis after the one fill of the liquid polymer.

FIG. 12 is an illustrative view illustrating DNA base sequences and waveform data in the vicinity of 600 bp in the first run (1st), the third run (3rd), and the eighth run (8th) in Example 1. The first run is first electrophoresis after one fill of the liquid polymer. The third run is third electrophoresis after the one fill of the liquid polymer. The eighth run is eighth electrophoresis after the one fill of the liquid polymer.

As illustrated in FIG. 11 and FIG. 12, as the number of runs after one fill of the liquid polymer increased, the waveform data slightly deteriorated, but the DNA base sequence could be analyzed without any problems. Specifically, in the vicinity of 645 bp in the eighth run illustrated in FIG. 12, these was a portion that could not be analyzed with sufficient precision, but the DNA base sequence could otherwise be analyzed with sufficiently high precision.

Illustration for Example 2 is omitted, but substantially the same result as that obtained in Example 1 was obtained.

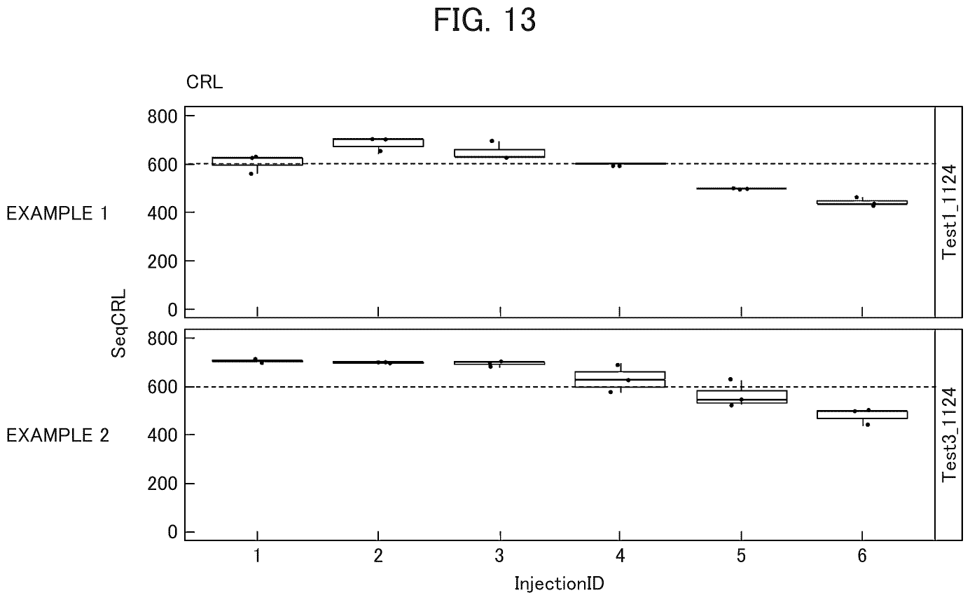

FIG. 13 is a graph illustrating statistical values of respective contiguous read lengths (CRL) in individual sample injection numbers (Injection IDs), i.e., the first to sixth runs in each of Example 1 and Example 2. Note that FIG. 13 illustrates the statistical values obtained by independently performing the same analysis three times.

As illustrated in FIG. 13, it was confirmed that, when 600 bp was determined to be a reference value, in each of Example 1 and Example 2, the CRL had cleared the reference value up to the fourth run, and the specification was sufficiently satisfied. It will be understood that, if 400 bp had been determined to be a reference value, in each of Example 1 and Example 2, CRL could have cleared the reference value up to the sixth run, and the specification could have been satisfied. Note that the reference value can optionally be changed depending on a length of a DNA base sequence intended to be analyzed. For example, when the DNA base sequence intended to be analyzed is a PCR amplification product and a length thereof can be expected in advance to be 300 bp, 400 bp, or the like, the length can be considered as the reference value. For example, when the length of the PCR amplification product was 300 bp, from the result illustrated in FIG. 13, it could be inferred that the specification could sufficiently be satisfied up to about eighth to tenth runs.

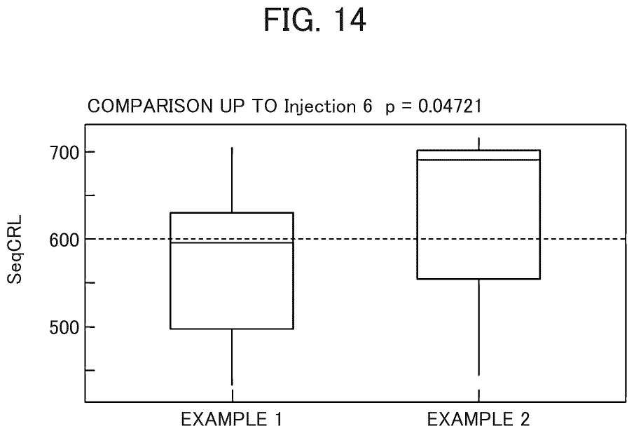

FIG. 14 is a graph showing, for comparison, total CRL statistical values in the first to sixth sample injection numbers (up to Injection 6) in Example 1 and Example 2 (p=0.04721). As illustrated in FIG. 14, it was confirmed that, in each of Examples 1 and 2, the specification could sufficiently be satisfied. It was also confirmed that Example 2 tended to have a higher CRL than Example 1. It was concluded that this was because, in Example 2, the second pre-run step S5 was not performed, and therefore the decomposition of urea contained in the liquid polymer was suppressed.

### [2] Examination 2

In Examination 2, the separation medium filling frequency was changed, and the capillary sequence DNA base sequence analysis was performed under the same conditions as those in Examples 1 and 2. Specifically, the analysis was performed as follows.

### Example 3

Example 3 set the separation medium filling frequency to 4 (i.e., set the number of times the second pre-run step S5, the second sample injection step S6, and the second electrophoretic step S7 were to be repeated to 3), continuously performed these in one set four times, and performed the total of 16-run analyses. In Example 3, analysis was performed in otherwise the same manner as in Example 1.

### Example 4

Example 4 set the separation medium filling frequency to 4 (i.e., set the number of times the second sample injection step S6 and the second electrophoretic step S7 were to be repeated to 3), continuously performed these in one set four times, and performed the total of 16-run analyses. In Example 4, analysis was performed in otherwise the same manner as in Example 2.

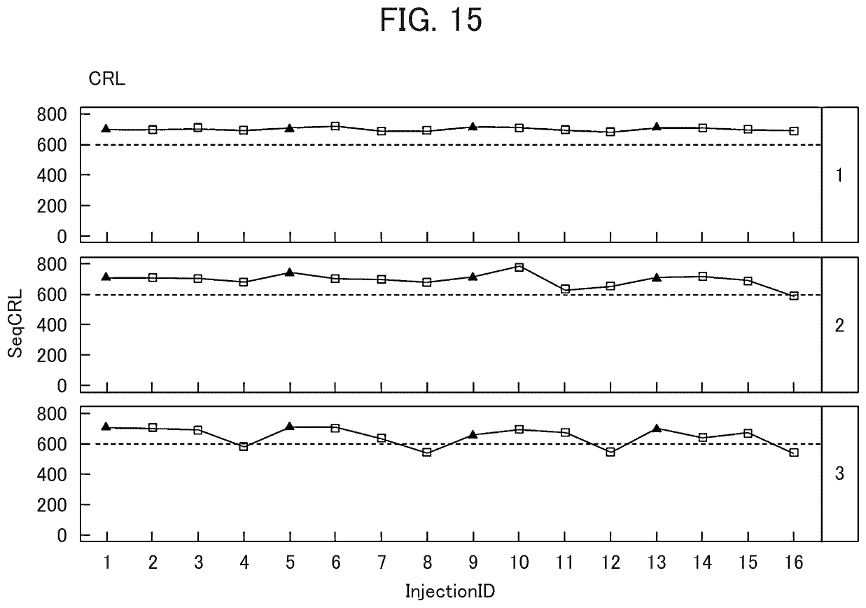

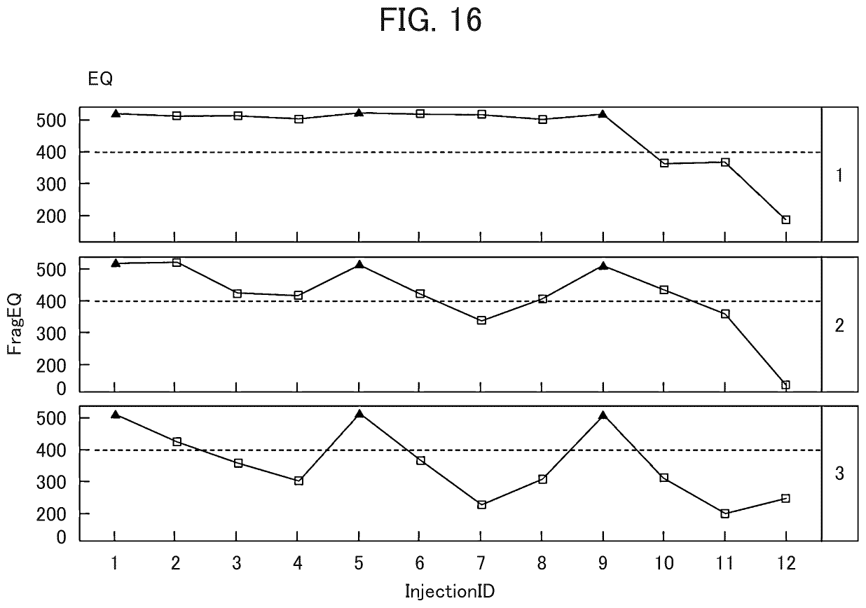

FIG. 15 is a graph continuously illustrating transitions of the CRL in DNA sequence analysis in the 1 to 16 sample injection numbers (Injection IDs), i.e., in the first to sixteenth DNA sequence analyses in Example 4. In the drawing, 1, 2, and 3 on the right side indicate the numbers of the capillaries. In other words, in FIG. 15, line graphs represent transitions of the CRL in the first to sixteenth runs in the three capillaries. In the drawing, each of the symbols “▴” represents a result of the first run after filling or refilling with (replacement of) the liquid polymer was performed. In the drawing, each of the symbols “□” represents a result of performing each of the second, third, and fourth runs by using the liquid polymer used in the first run.

As illustrated in FIG. 15, due to individual differences between the capillaries 1 to 3, some analyses were well performed and the others were not and, when the number of the runs after one fill of the liquid polymer increased, there was the capillary in which the CRL slightly decreased. However, the DNA base sequence could be analyzed without any problems. From this, it was confirmed that, when a criterion for the CRL was set to 600 bp (when a length of the DNA base sequence intended to be analyzed was 600 bp), the specification could sufficiently be satisfied only by setting the separation medium filling frequency to 4. Note that, from the result illustrated in FIG. 15, it was inferred that, as long as the criterion for the CRL had been, e.g., 500 bp or less (as long as the length of the DNA base sequence intended to be analyzed had been 500 bp or less), even when the separation medium filling frequency was increased to 5 or more, the specification could sufficiently be satisfied.

FIG. 16 is a graph continuously illustrating transitions of EQ representing a maximum base length in a range in which single base separation is possible in fragment analysis in the 1 to 12 sample injection numbers (Injection IDs), i.e., in the first to twelfth runs in Example 4. In the drawing, 1, 2, and 3 on the right side indicate the numbers of the capillaries. In other words, in FIG. 16, line graphs represent the transitions of the EQ in the first to twelfth runs in the three capillaries. In the drawing, each of the symbols “▴” represents a result of the first run after filling or refilling with (replacement of) the liquid polymer was performed. In the drawing, each of the symbols “□” represents a result of performing each of the second, third, and fourth runs by using the liquid polymer used in the first run.

As illustrated in FIG. 16, due to individual differences between the capillaries 1 to 3, some analyses were well performed and the others were not and, when the number of the runs after one fill of the liquid polymer increased, there was the capillary in which the EQ slightly decreased. However, the DNA base sequence could be analyzed without any problems. From this, it was confirmed that, when a criterion for the EQ was set to 400 bp (when a length of the DNA base sequence intended to be analyzed was 400 bp), the specification could sufficiently be satisfied only by setting the separation medium filling frequency to 4. Note that, from the result illustrated in FIG. 16, it was inferred that, as long as the criterion for the EQ had been, e.g., 200 bp or less (as long as the length of the DNA base sequence intended to be analyzed had been 200 bp or less), even when the separation medium filling frequency was increased to 5 or more, the specification could sufficiently be satisfied.

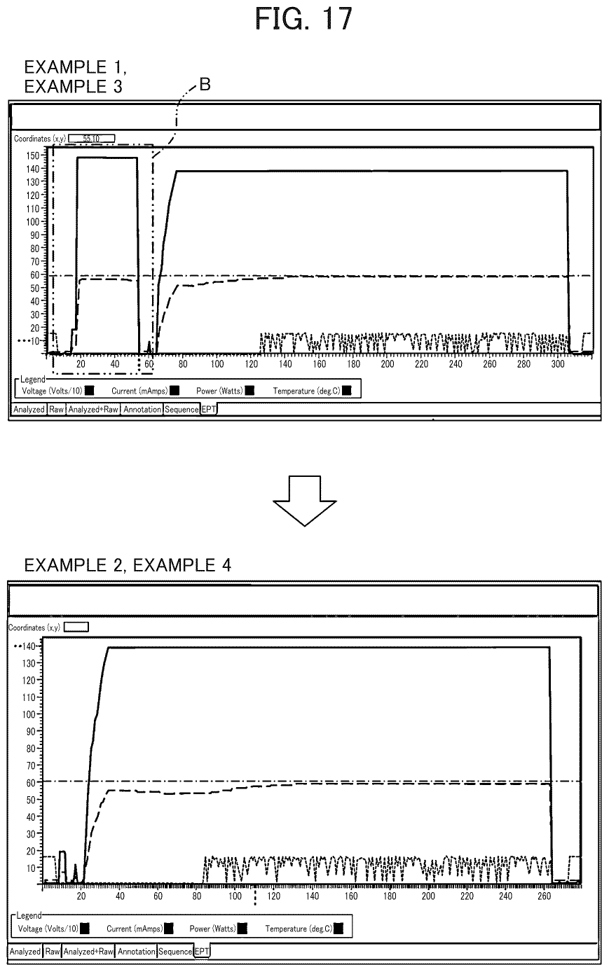

FIG. 17 is an illustrative view illustrating a second-run analysis time difference between each of Examples 1 and 3 in which a pre-run is performed for each run and each of Examples 2 and 4 in which a pre-run is performed only when the first run is performed after liquid polymer filling and no pre-run is performed in each of the second and subsequent runs in comparison to each other. It can be said that, in terms of performing a pre-run for each run, Examples 1 and 3 and the conventional method are the same.

As illustrated in FIG. 17, in each of Examples 1 and 3 (also in the conventional method), the pre-run is performed for each run and, accordingly, in the second run, voltage application for the pre-run indicated by the portion B at the beginning of the analysis indicated by the two-dot broken line on the left side of the upper illustrative view in FIG. 17 is performed.

By contrast, in each of Examples 2 and 4, no pre-run is performed in the second and subsequent runs after the liquid polymer filling and, accordingly, as illustrated in the lower illustrative view in FIG. 17, the voltage application for the pre-run indicated by the portion B in the upper illustrative view in FIG. 17 is unnecessary in the second run. Therefore, it is confirmed that, in each of Examples 2 and 4, an analysis time can be reduced for each of the second and subsequent runs after the liquid polymer filling. Specifically, an abscissa axis in each of the upper and lower illustrative views in FIG. 17 represents an index of the analysis time. In each of Examples 1 and 3 illustrated in the upper illustrative view in FIG. 17, the index from the start of the analysis to the end thereof is about 300 while, in each of Examples 2 and 4 illustrated in the lower illustrative view in FIG. 17, the index from the start of the analysis to the end thereof is about 265. From these, it was confirmed that, in each of Examples 2 and 4, the analysis time could be reduced by about 10% compared to that in each of Examples 1 and 3 (and the conventional method).

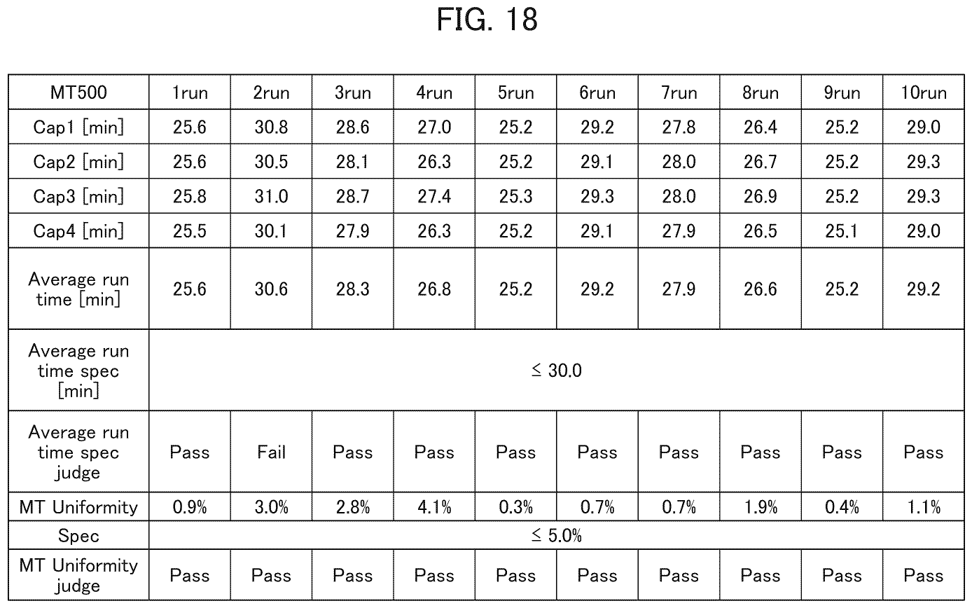

FIG. 18 is a table showing respective run times in the first to tenth runs in four capillaries (Cap1 to Cap4) and the like in Example 4. The table illustrated in FIG. 18 shows these run times [min], an average run time (Average run time) [min], a specification of the average run time (Average run time spec) [min], judgement of the specification of the average run time (Average run time spec judge), uniformity (MT Uniformity) of a migration time (Migration Time), a specification (Spec) of the uniformity of the migration time, and judgment of the specification of the uniformity of the migration time (MT Uniformity judge).

As illustrated in the table in FIG. 18, the run time in the second run was elongated in each of the Cap1 to Cap4, and accordingly an average run time was also elongated. As a result, the second run could not satisfy a specification of the average run time, which was 30 min or less, and a judgment result thereof with respect to the specification of the average run time was a failure (Fail). A judgment result of each of the other first and third to tenth runs was a success (Pass). In addition, as illustrated in the table in FIG. 18, in total, the run time ranged from 25 minutes to 30 minutes, and a slight variation was observed.

Meanwhile, each of the uniformities of the migration times satisfied the specification of the uniformity of the migration time, which was 5.0% or less, and each of the first to tenth runs was successful.

While a detailed description has been given of the method for continuously using the separation medium according to the present invention by using the embodiments and the examples, the present invention is not limited to the embodiments described above, and encompasses various modifications. For example, the above-described embodiments have been described in detail in order to facilitate the understanding of the present invention, and the present invention is not necessarily limited to those including all of the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

### LIST OF REFERENCE SIGNS

1 Electrophoretic device (present device)
10 Capillary array
20 Separation medium container
30 Anode-side buffer container
31 Anode-side cleaning tank
32 Anode-side electrophoretic buffer tank
33 Sample introduction buffer tank
40 Cathode-side buffer container
41 Waste liquid tank
42 Cathode-side cleaning tank
43 Cathode-side electrophoretic buffer tank
50 Sample container
60 Liquid feeding mechanism
61 Plunger
80 Sampler base
85 Y-axis driver
90 Z-axis driver
95 X-axis driver
100 Sample tray
101 Guide
110 Thermostatic bath unit
115 Electrode
120 Thermostatic bath door
121 First current meter
122 High-voltage power source
123 Second current meter
124 Hollow electrode
125 Capillary
125a Leading end
126 Load header
127 Capillary head
128 Detection unit
129a, 129b GND
130 Irradiation detection unit
141 Micro-controller
142 Controller
150 Auto sampler unit
160 Irradiation detection/thermostatic bath unit
S1 Separation medium filling step
S2 First pre-run step
S3 First sample injection step
S4 First electrophoretic step
S5 Second pre-run step
S6 Second sample injection step
S7 Second electrophoretic step

1. A method for continuously using a separation medium, the method comprising:
a separation medium filling step of filling a capillary with the separation medium;
a first pre-run step of applying a voltage in the same direction as that in which electrophoresis is to be performed to the capillary filled with the separation medium to perform a pre-run;
a first sample injection step of injecting a first-time sample into the capillary subjected to the pre-run;
a first electrophoretic step of applying a voltage to the capillary into which the first-time sample has been injected to perform first electrophoresis;
a second pre-run step of applying a voltage in the same direction as that in which electrophoresis is to be performed to the capillary after the first electrophoretic step to perform a pre-run;
a second sample injection step of injecting a next-time sample into the capillary subjected to the second pre-run step; and
a second electrophoretic step of applying a voltage to the capillary into which the next-time sample has been injected to perform next electrophoresis,
wherein, after repeatedly performing the second pre-run step, the second sample injection step, and the second electrophoretic step a preliminarily set number of times, the method ends analysis using the separation medium with which the capillary is filled in the separation medium filling step performed once, then returns to the separation medium filling step to replace the separation medium in the capillary, and performs each of the steps including and subsequent to the first pre-run step by using a new separation medium an intended number of times.

2. A method for continuously using a separation medium, the method comprising:
a separation medium filling step of filling a capillary with the separation medium;
a first pre-run step of applying a voltage in the same direction as that in which electrophoresis is to be performed to the capillary filled with the separation medium to perform a pre-run;
a first sample injection step of injecting a first-time sample into the capillary subjected to the pre-run;
a first electrophoretic step of applying a voltage to the capillary into which the first-time sample has been injected to perform first electrophoresis;
a second sample injection step of injecting a next-time sample into the capillary after the first electrophoretic step; and
a second electrophoretic step of applying a voltage to the capillary into which the next-time sample has been injected to perform next electrophoresis,
wherein, after repeatedly performing the second sample injection step and the second electrophoretic step a preliminarily set number of times, the method ends analysis using the separation medium with which the capillary is filled in the separation medium filling step performed once, then returns to the separation medium filling step to replace the separation medium in the capillary, and performs each of the steps including and subsequent to the first pre-run step by using a new separation medium an intended number of times.

3. The method for continuously using the separation medium according to claim 1,
wherein the separation medium is a liquid polymer.

4. The method for continuously using the separation medium according to claim 1,
wherein a frequency of filling with the separation medium in the separation medium filling step is set via a graphical user interface.

5. The method for continuously using the separation medium according to claim 2, wherein the separation medium is a liquid polymer.

6. The method for continuously using the separation medium according to claim 2, wherein a frequency of filling with the separation medium in the separation medium filling step is set via a graphical user interface.
